(19) United States
(12) Patent Application Publication
(10) Pub. No.: US 2024/0370990 A1
(43) Pub. Date: Nov. 7, 2024

(54) SEAL TESTING SYSTEM FOR EXTERIOR REARVIEW MIRROR ATTACHMENT AT SIDE OF VEHICLE

(71) Applicant: Magna Mirrors of America, Inc., Holland, MI (US)

(72) Inventor: Dale E. Gathergood, Grand Haven, MI (US)

(21) Appl. No.: 18/650,222

(22) Filed: Apr. 30, 2024

Related U.S. Application Data
(60) Provisional application No. 63/499,543, filed on May 2, 2023.

(51) Int. Cl. G06T 7/00; B60R 1/06; B60R 11/00

(52) U.S. Cl. CPC G06T 7/0006; B60R 1/06; B60R 11/00; B60R 2011/004; B60R 2011/0052; G06T 2207/30252

(57) ABSTRACT

A method of testing a seal of a rearview mirror assembly includes providing a mounting arm for a vehicular exterior rearview mirror assembly. The mounting arm includes an attachment end configured to be mounted at an exterior portion of a vehicle and providing a mounting element that is at least partially transparent. The attachment end is mounted to the mounting element with sealant disposed between the mounting arm and the mounting element to establish a test seal between the mounting arm and the mounting element. A shim is disposed between the mounting arm and the mounting element. A thickness of the shim is based on a threshold interference level of the test seal. Based on a determination of a gap between the mounting arm and the mounting element, determining that an interference between the mounting arm and the sealant is less than the threshold interference level of the test seal.

### CROSS REFERENCE TO RELATED APPLICATION

The present application claims the filing benefits of U.S. provisional application Ser. No. 63/499,543, filed May 2, 2023, which is hereby incorporated herein by reference in its entirety.

### FIELD OF THE INVENTION

The present invention relates to exterior rearview mirror assemblies for vehicles.

### BACKGROUND OF THE INVENTION

It is known to provide a vehicular exterior rearview mirror assembly at a side of a vehicle. The vehicular exterior rearview mirror assembly is mounted to the vehicle with sealant forming a seal between the side of the vehicle and the vehicular exterior rearview mirror assembly.

### SUMMARY OF THE INVENTION

The present invention provides method of testing a seal of a rearview mirror assembly, the method that includes providing a rearview mirror assembly configured to be mounted at a side of a vehicle and providing a mounting surface. The mounting surface is at least partially transparent. The method includes mounting the rearview mirror assembly to the mounting surface using sealant configured to create a seal between the rearview mirror assembly and the mounting surface. The method includes determining a quality of the seal through the at least partially transparent mounting surface.

These and other objects, advantages, purposes and features of the present invention will become apparent upon review of the following specification in conjunction with the drawings.

### BRIEF DESCRIPTION OF THE DRAWINGS

FIGS. 1 and 2 are views of a vehicular exterior rearview mirror assembly mounted at a side of a vehicle;

FIGS. 3A-3C are views of a body portion of the vehicle at which the exterior rearview mirror assembly is configured to be mounted, showing example positions of sealant disposed between a mounting arm of the exterior rearview mirror assembly and the body portion of the vehicle;

FIG. 4 is a perspective view of the exterior rearview mirror assembly mounted to a transparent mounting surface;

FIG. 5 is a perspective view of exemplary shims;

FIG. 6 is a perspective view of exemplary feeler gauges; and

FIGS. 7 and 8 are schematic views of the exterior rearview mirror assembly mounted to the transparent mounting surface with interference.

### DESCRIPTION OF THE PREFERRED EMBODIMENTS

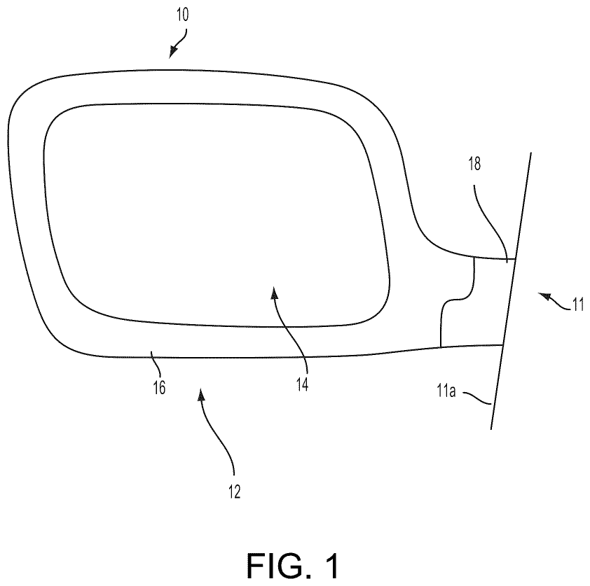

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIG. 1). The mirror casing 16 or head portion 12 may be fixedly attached at a mounting arm or base 18 at the side of the vehicle 11 or may be movably mounted to the mounting arm or base or portion 18, and may comprise a breakaway mirror (where the mirror head portion may be manually pivoted about the mounting arm or base) or may comprise a powerfold mirror (where the mirror head portion may be pivoted via an actuator assembly or adjustment device). The mounting arm or base 18 of the mirror assembly 10 is mounted at the side 11a of the host or subject vehicle 11, with the reflective element 14 providing a rearward field of view along the respective side of the vehicle 11 to the driver of the vehicle.

Exterior rearview mirrors are generally sealed to the side of the vehicle to preclude wind, water, and other containments from entering the mirror casing and/or the door of the vehicle. The amount of sealant and the pattern of sealant to apply to the mirror or mirror mount to seal the mirror to the vehicle may be tested before being put into production and/or when troubleshooting issues. Conventionally, the sealant is tested by spraying chalk or a chalk-like material on the door, fixing the mirror to the door, then removing the mirror to evaluate the witness mark left by the chalk. However, this test may only show where sealant and chalk came into contact and does not provide any information relating to the amount or quality of seal. Because there are many factors (e.g., noise factors) that may be involved in determining root cause of a failure (e.g., a leak), determining an amount or quality of the seal can be important.

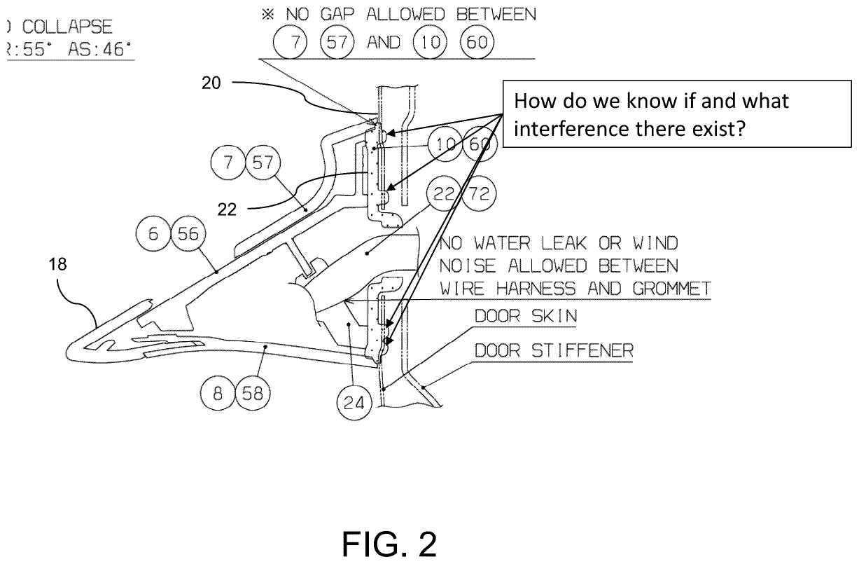

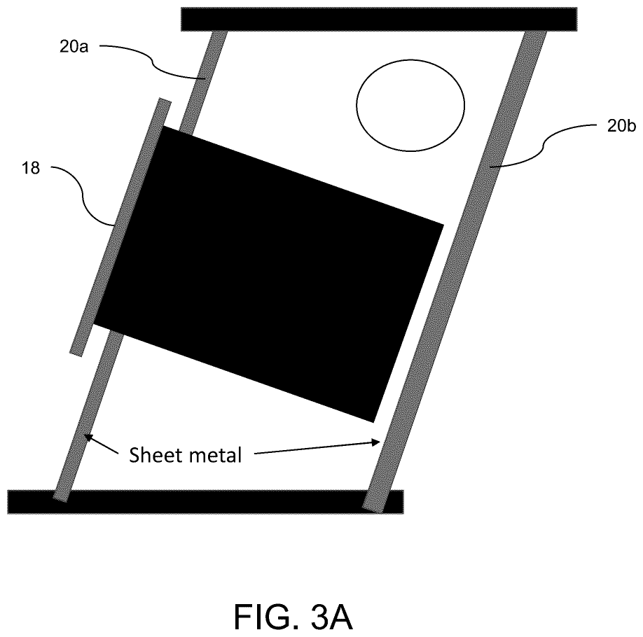

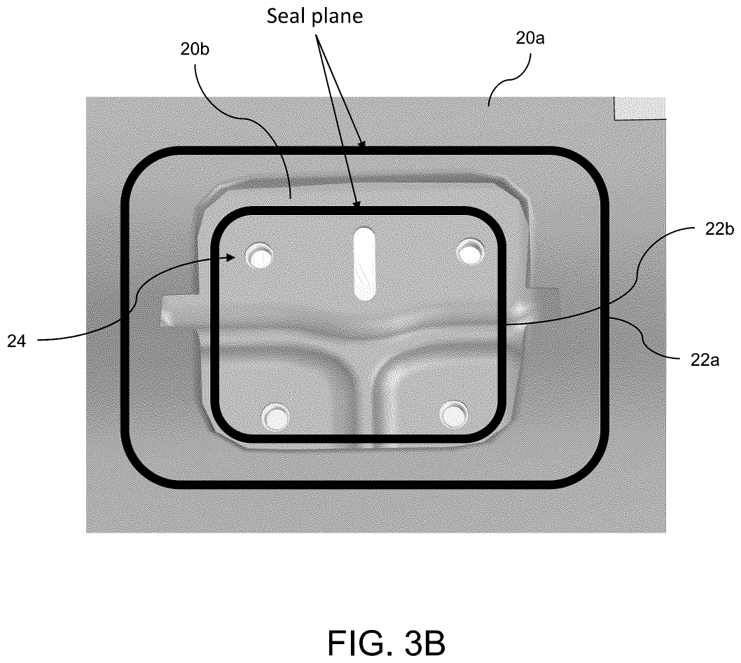

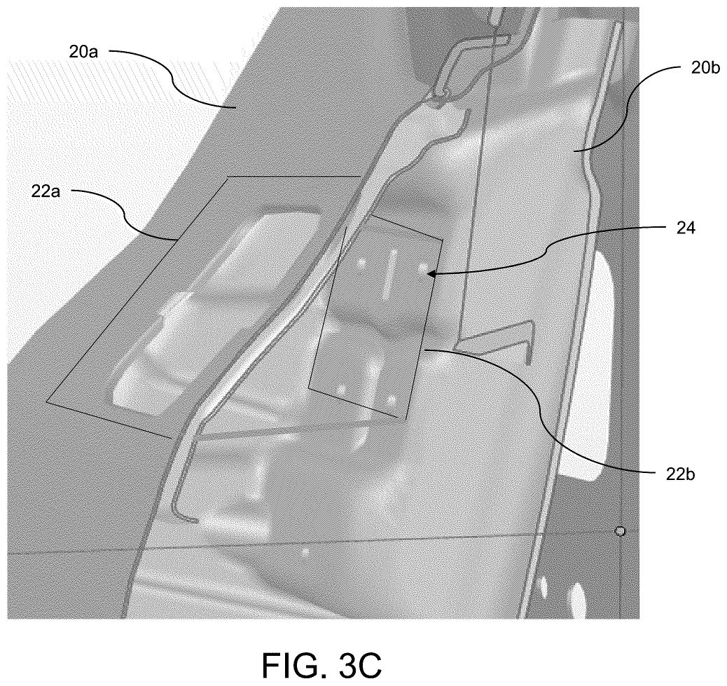

For example, and as shown in FIGS. 2 and 3A-3C, the mounting arm 18 of the exterior rearview mirror assembly 10 may mount the mirror assembly at a body portion 20 of the vehicle 11, such as a panel of a door or a body panel of the vehicle 11, with sealant 22 disposed between portions of the mounting arm 18 and the body portion 20. In the illustrated example, the body portion 20 includes an exterior panel or surface or structure 20a providing an exterior or Class A surface of the vehicle 11 and an interior panel or surface or structure 20b. A cavity may be formed between the exterior panel 20a and the interior panel 20b, such as for routing a vehicular wire harness to the mirror assembly 10. The mounting arm 18 of the mirror assembly 10 may extend at least partially through an aperture in the body portion 20 to mount or attach to the interior panel 20b, with sealant 22 disposed between the mounting arm 18 and the exterior panel 20a and the interior panel 20b. That is, the sealant 22 may be disposed between the mounting arm 18 and the exterior panel 20a at a first sealing plane or position 22a and sealant 22 may be disposed between the mounting arm 18 and the interior panel 20b at a second sealing plane or position 22b.

With the mounting arm 18 positioned at a mounting portion or surface 24 of the body portion 20, and with the sealant 22 disposed between the mounting arm 18 and the respective panels of the body portion 20, fasteners (e.g., bolts or other suitable threaded fasteners) mount the mounting arm 18 to the body portion 20. The mounting surface 24 of the body portion 20 may include a surface of the interior panel 20b having a pattern of through holes configured to receive the bolts or other threaded fasteners therethrough. Attaching the mounting arm 18 to the body portion 20 may cause the sealant 22 to at least partially compress between the mounting arm 18 and the body portion 20 and form the seal. Because the body portion 20 may provide a non-uniform or contoured mounting surface 24 and/or because the fasteners may apply non-uniform sealing pressure at the seal, the amount and/or pattern of sealant 22 may be adjusted to provide a uniform and continuous seal between the mounting arm 18 and the body portion 20.

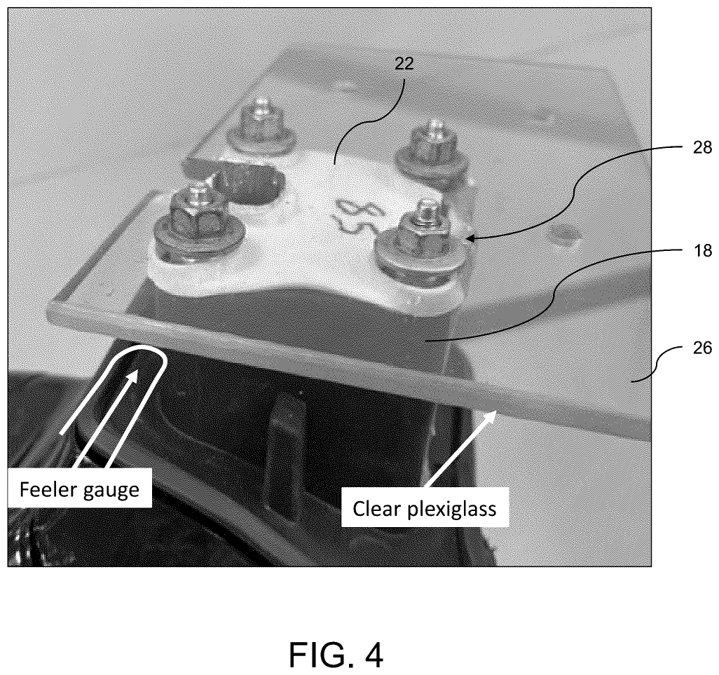

Implementations herein include a method for testing the seal of an exterior rearview mirror attachment or other component at a vehicle structure (such as at a vehicular side door structure). Referring now to FIG. 4, the method includes obtaining or providing a clear or at least partially transparent mount material 26 (e.g., a plastic or acrylic or acrylic glass) that includes a mounting portion or surface 28 having the same shape or contour as the sealing surface (e.g., the side of the vehicle or the body panel 20 at which the mounting arm 18 is to be attached). Further, the mounting surface 28 of the mount material 26 may include a pattern of through holes configured to receive bolts or other threaded fasteners that corresponds or matches the pattern of through holes of the body portion 20. Optionally, the method includes adding (e.g., drilling) the mounting holes to the mount material 26 that match the mounting holes required to mount the mirror. The mirror may then be mounted (e.g., via one or more bolts or the like) to the transparent mount material so that the seal can be directly observed through the transparent material. That is, the sealant 22 is disposed between the mounting arm 18 of the mirror assembly and the mount material 26 in a corresponding pattern and/or amount as that used at the vehicle, and the mounting arm 18 is fastened to the mount material 26 to at least partially compress the sealant 22 and form a test seal that mimics or represent or generally corresponds to the seal at the vehicle. Because the mount material is at least partially transparent, the test seal between the mounting arm 18 and the mount material 26 may be directly observed, such as to confirm that the test seal is representative of an equivalent seal when the mirror assembly is equipped at the vehicle.

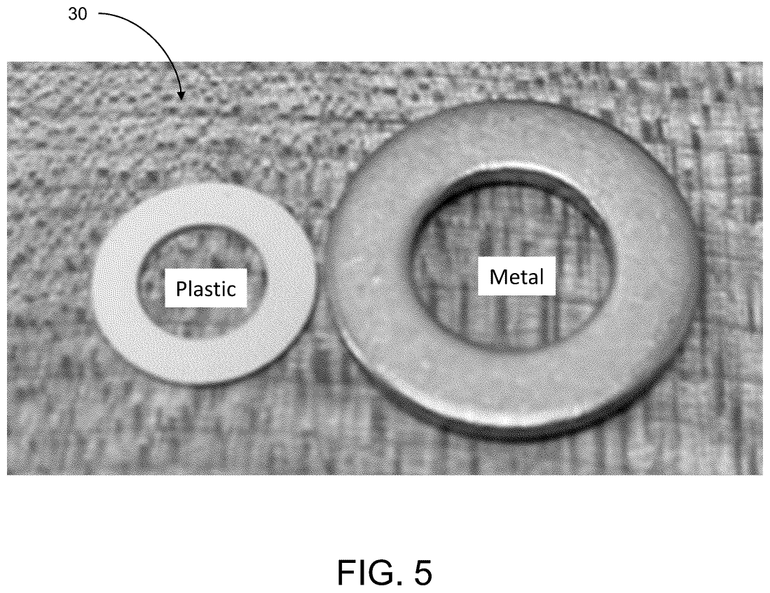

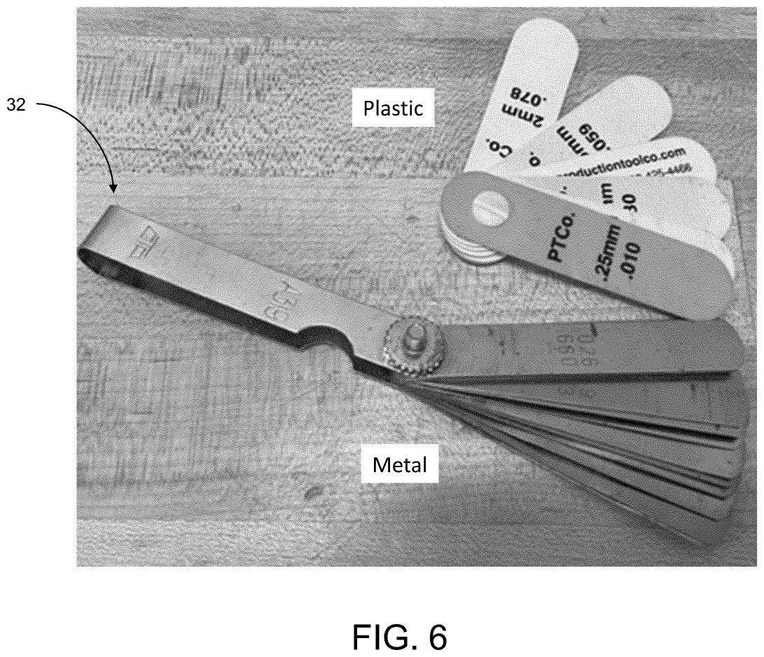

Optionally, one or more shims 30 (FIG. 5) may be added between the mirror mounting arm 18 and the mount material 26 (e.g., at one or more stud scolders) to determine an amount of sealing or an amount of interference provided by the seal, where the amount of interference may be the amount of compression of the sealant 22 caused by attachment of the mounting arm 18. That is, the shim 30 may be disposed between the mounting arm 18 and the mount material 26 and/or the sealant 22, such as about one or more of the fasteners, to decrease the compression of the sealant 22 caused by attachment of the mounting arm 18 by the thickness of the shim 30. For example, when a 3 mm thick seal is desired, one or more 3 mm thick shims may be added to the stud scolders that mount the mirror mounting arm 18 to the mount material 26. A feeler gauge 32 (FIG. 6) may be slidably disposed between the mounting arm 18 and the mount material 26 at the seal to measure any gap that exists between the mount material 26 and the mirror mounting arm 18. Presence of any gap may indicate that there is insufficient sealant to meet the desired seal thickness (e.g., 3 mm). For example, when a 3 mm thick seal is desired, if only a 2 mm thick seal is achieved, the feeler gauge may measure a 1 mm gap when the 3 mm thick shim 30 is disposed between the mounting arm 18 and the mount material 26, indicating the seal thickness is 1 mm less than desired.

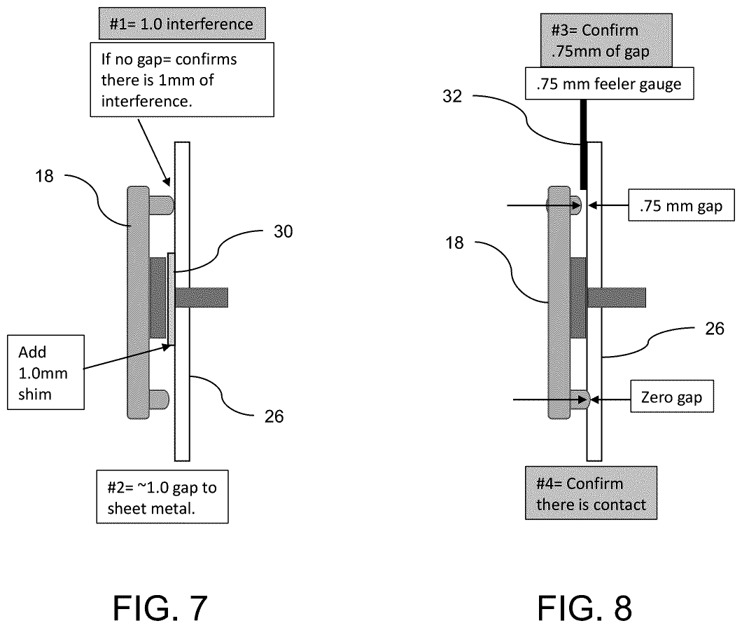

As another example, and as shown in FIG. 7, a 1 mm thick shim 30 is added, spacing the mirror mounting arm 18 from the mount material 26 by an additional 1 mm. Using the feeler gauge 32, any gap between the mirror mounting arm 18 and the mount material 26 may be measured. In this example, no gap confirms there is at least 1 mm of interference. Continuing the example, and as shown in FIG. 8, when the shim 30 is removed, the feeler gauge 32 may confirm a 0.75 mm gap. Various types of shims and feeler gauges may be used (e.g., plastic and/or metal).

In other words, FIG. 7 depicts that to determine that a minimum or threshold amount of interference exists about the seal (e.g., a threshold interference of 1 mm), a shim 30 having a thickness equal to the threshold amount of interference (e.g., a 1 mm thick shim) is disposed between the mounting arm 18 and the mount material 26 and/or sealant 22. At positions about the seal where no gap is measured between the mounting arm 18 and the mount material 26 (e.g., using the feeler gauge 32), the seal may be determined to have at least the threshold level of interference. At positions about the seal where a gap is measured between the mounting arm 18 and the mount material (e.g., using the feeler gauge 32), the seal may be determined to have less than the threshold level of interference, where the deficiency of the seal at these positions may be equal to the measured thickness of the gap. Thus, the amount and/or pattern of sealant 22 may be adjusted based on the determined gaps.

Similarly, FIG. 8 depicts that the shim 30 may be removed from between the mounting arm 18 and the mount material 26 and/or sealant 22 to determine positions about the seal where the mounting arm 18 contacts the mount material 26 and/or sealant 22 and positions where the mounting arm 18 does not contact the mount material 26 and/or sealant 22. The feeler gauge 32 may measure any gaps between the mounting arm 18 and the mount material 26 and/or sealant 22 to determine a minimum thickness of additional sealant 22 needed to fill the gap.

Thus, implementations herein include a method of testing or evaluating a seal of a rearview mirror assembly (or any other applicable component) to a vehicle. The method may include mounting the rearview mirror assembly to a mounting surface that is at least partially transparent. The rearview mirror assembly is mounted using sealant to create a seal between the rearview mirror assembly and the mounting surface. The method includes determining a quality of the seal by viewing the seal through the at least partially transparent mounting surface. The quality of the seal may include a size of the seal, an amount of the seal, a pattern of the seal, etc. One or more shims may be added between the rearview mirror assembly and the mounting surface to represent a threshold size of the seal. A feeler gauge or other tool may measure any gap between the rearview mirror assembly and the mounting surface to determine whether the threshold size of the seal is exceeded. An image sensor (e.g., a camera or the like) may be used to automatically obtain or capture image data of the seal (e.g., by having a field of view that encompasses the seal through the at least partially transparent mounting surface). The image data captured by the sensor data may be processed (e.g., via a processor) to determine the quality of the seal. The method allows manufacturers or other entities to determine exactly how well the rearview mirror assembly will seal to the door and whether the mirror is to print, the door is to print, etc.

The mirror assembly may comprise any suitable construction, such as, for example, a mirror assembly with the reflective element being nested in the mirror casing and with the mirror casing having a curved or beveled perimeter edge around the reflective element and with no overlap onto the front surface of the reflective element (such as by utilizing aspects of the mirror assemblies described in U.S. Pat. Nos. 7,255,451; 7,289,037; 7,360,932; 8,049,640; 8,277,059 and/or 8,529,108, or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Pat. Nos. 10,099,618; 9,827,913; 9,598,016; 9,346,403; 9,174,578; 8,915,601; 8,730,553 and/or 8,508,831, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

Changes and modifications in the specifically described embodiments may be carried out without departing from the principles of the present invention, which is intended to be limited only by the scope of the appended claims as interpreted according to the principles of patent law.

1. A method of testing a seal of a vehicular exterior rearview mirror assembly, the method comprising:
providing a mounting arm for a vehicular exterior rearview mirror assembly, wherein the mounting arm comprises an attachment end configured to be mounted at an exterior portion of a vehicle;
providing a mounting element, wherein the mounting element is at least partially transparent;
mounting the attachment end of the mounting arm to the mounting element with sealant disposed between the attachment end of the mounting arm and the mounting element to establish a test seal at the mounting arm that is viewable through the mounting element;
with the mounting arm mounted to the mounting element, and based on a view of the test seal through the mounting element, determining that the test seal provides an intended seal between the mounting arm and the mounting element;
wherein mounting the attachment end of the mounting arm to the mounting element comprises disposing a shim between the attachment end of the mounting arm and the mounting element, and wherein a thickness of the shim is based on a threshold interference level of the test seal; and
with the mounting arm mounted to the mounting element, and based on determination of a gap between the attachment end of the mounting arm and the mounting element at the test seal, determining that an interference between the mounting arm and the sealant at the test seal is less than the threshold interference level of the test seal.

2. The method of claim 1, wherein determining that the test seal provides the intended seal comprises (i) operating an image sensor viewing the test seal through the mounting element to capture image data and (ii) determining, via processing of the captured image data, that the test seal provides the intended seal.

3. The method of claim 2, wherein determination of the gap is based on processing of the captured image data.

4. The method of claim 1, wherein determination of the gap comprises using a feeler gauge.

5. The method of claim 4, wherein the feeler gauge comprises one selected from the group consisting of (i) a plastic feeler gauge and (ii) a metal feeler gauge.

6. The method of claim 1, wherein the shim comprises one selected from the group consisting of (i) a plastic shim and (ii) a metal shim.

7. The method of claim 1, wherein, based on determination of no gap between the attachment end of the arm and the mounting element at the test seal, determining that the interference between the mounting arm and the sealant at the test seal is greater than or equal to the threshold interference level of the test seal.

8. The method of claim 1, wherein a shape of the mounting element corresponds to a shape of the exterior portion of the vehicle.

9. The method of claim 8, wherein the exterior portion of the vehicle comprises one selected from the group consisting of (i) a vehicular door panel of the vehicle and (ii) a vehicular body panel of the vehicle.

10. The method of claim 1, wherein the mounting element comprises a pattern of mounting holes that corresponds to a pattern of mounting holes at the exterior portion of the vehicle.

11. The method of claim 10, wherein mounting the attachment end of the mounting arm to the mounting element comprises attaching the attachment end of the mounting arm to the mounting element via the one or more mounting holes.

12. The method of claim 1, wherein determining that the test seal provides the intended seal comprises determining that the test seal is representative of a seal between the mounting arm and the exterior portion of the vehicle when the attachment end is mounted at the exterior portion of the vehicle.

13. A method of testing a seal of a vehicular exterior rearview mirror assembly, the method comprising:
providing a mounting arm for a vehicular exterior rearview mirror assembly, wherein the mounting arm comprises an attachment end configured to be mounted at an exterior portion of a vehicle;
providing a mounting element, wherein the mounting element is at least partially transparent;
mounting the attachment end of the mounting arm to the mounting element with sealant disposed between the attachment end of the mounting arm and the mounting element to establish a test seal at the mounting arm that is viewable through the mounting element;
with the mounting arm mounted to the mounting element, and based on a view of the test seal through the mounting element, determining that the test seal provides an intended seal between the mounting arm and the mounting element;
wherein determining that the test seal provides the intended seal comprises (i) operating an image sensor viewing the test seal through the mounting element to capture image data and (ii) determining, via processing of the captured image data, that the test seal provides the intended seal;
with the mounting arm mounted to the mounting element, and based on determination of a gap between the attachment end of the mounting arm and the mounting element at the test seal, determining that an interference between the mounting arm and the sealant at the test seal is less than a threshold interference level of the test seal; and
wherein, based on determination of no gap between the attachment end of the arm and the mounting element at the test seal, determining that the interference between the mounting arm and the sealant at the test seal is greater than or equal to the threshold interference level of the test seal.

14. The method of claim 13, wherein determination of the gap and determination of no gap are each based on processing of the captured image data.

15. The method of claim 13, wherein determination of the gap and determination of no gap each comprises using a feeler gauge.

16. The method of claim 13, wherein a shape of the mounting element corresponds to a shape of the exterior portion of the vehicle.

17. The method of claim 13, wherein mounting the attachment end of the mounting arm to the mounting element comprises disposing a shim between the attachment end of the mounting arm and the mounting element, and wherein a thickness of the shim is based on the threshold interference level of the test seal.

18. A method of testing a seal of a vehicular exterior rearview mirror assembly, the method comprising:
providing a mounting arm for a vehicular exterior rearview mirror assembly, wherein the mounting arm comprises an attachment end configured to be mounted at an exterior portion of a vehicle;
providing a mounting element, wherein the mounting element is at least partially transparent, and wherein a shape of the mounting element corresponds to a shape of the exterior portion of the vehicle, and wherein the mounting element comprises a pattern of mounting holes that corresponds to a pattern of mounting holes at the exterior portion of the vehicle;
mounting the attachment end of the mounting arm to the mounting element via the one or more mounting holes and with sealant disposed between the attachment end of the mounting arm and the mounting element to establish a test seal at the mounting arm that is viewable through the mounting element;
with the mounting arm mounted to the mounting element, and based on a view of the test seal through the mounting element, determining that the test seal provides an intended seal between the mounting arm and the mounting element;
wherein mounting the attachment end of the mounting arm to the mounting element comprises disposing a shim between the attachment end of the mounting arm and the mounting element, and wherein a thickness of the shim is based on a threshold interference level of the test seal; and
with the mounting arm mounted to the mounting element, and based on determination of a gap between the attachment end of the mounting arm and the mounting element at the test seal, determining that an interference between the mounting arm and the sealant at the test seal is less than the threshold interference level of the test seal.

19. The method of claim 18, wherein determination of the gap comprises using a feeler gauge.

20. The method of claim 18, wherein, based on determination of no gap between the attachment end of the arm and the mounting element at the test seal, determining that the interference between the mounting arm and the sealant at the test seal is greater than or equal to the threshold interference level of the test seal.

21. The method of claim 18, wherein the exterior portion of the vehicle comprises one selected from the group consisting of (i) a vehicular door panel of the vehicle and (ii) a vehicular body panel of the vehicle.
